(19) United States
(12) Patent Application Publication
(10) Pub. No.: US 2006/0272624 A1
(43) Pub. Date: Dec. 7, 2006

(54) Device for whirling water

(76) Inventor: Bertil Pettersson, Orkelljunga (SE)

Correspondence Address: HARNESS, DICKEY & PIERCE, P.L.C., P.O. BOX 8910, RESTON, VA, 20195, US

(21) Appl. No.: 10/544,611

(22) PCT Filed: Feb. 6, 2004
(86) PCT No.: PCT/SE04/00160

§ 371 Date: May 8, 2006

(30) Foreign Application Priority Data
Feb. 7, 2003 (SE) 0300320-9

(51) Int. Cl. F02M 25/07

(52) U.S. Cl. 123/568.12; 239/463; 60/902

(57) ABSTRACT

Devices and Methods are disclosed for whirling a liquid including water, and further for different uses of such a device. The device includes a vortex unit including seven essentially parallel elongate helical elements, of which six are positioned around the seventh. The device may be used, for instance, for improving the performance of a coolant, for exhaust emission control, and/or for reducing the effect of electromagnetic radiation in an environment.

### TECHNICAL FIELD OF THE INVENTION

The present invention relates to devices and methods for whirling a liquid comprising water, and further to different uses of such a device.

### BACKGROUND OF THE INVENTION

The Molecular Structure of Water

Water is a unique and peculiar liquid. Unlike other molecules of about the same size, such as ammonia, methane, hydrogen sulphide, and carbon dioxide, water acts as a liquid at room temperature while others remain gases. Unlike other liquids, water expands at the phase shift to solid state—the maximum density of liquid water is near 4° C., not the freezing point. Water has a very high surface tension. It has an extraordinary capacity of storing heat and the greatest dielectric coefficient of any liquid. Further, it is an excellent solvent for salts and polar molecules—the ideal solvent for the chemical processes in biological systems. All these properties of water are a consequence of its ‘polarity’, the dipolar character of the water molecule [1] (A list of references will be found after the Detailed Description of Preferred Embodiments).

The water molecule, H₂O, is bonded together by covalent bonds; the single electron of each hydrogen atom H is shared with one of the six outer-shell electrons of the oxygen atom. Within the intramolecular structure of water, the atoms are arranged in a, slightly distorted, tetrahedral arrangement, in which the angle between the bonds is 104.5° [2].

The H₂O molecule is electrically neutral. However, the positive and negative charges are not distributed uniformly. The electronic (negative) charge is concentrated at the oxygen end of the molecule. This charge displacement constitutes an electric dipole. Since opposite charges attract, the partially positive hydrogen atom on one water molecule is electrostatically attracted to the partially negative oxygen atom on a neighbouring molecule. This is called ‘hydrogen bonding’. The hydrogen bond is somewhat longer than the covalent O—H bond, which means that it is considerably weaker [2].

In ice each water molecule is hydrogen-bonded to four neighbouring water molecules, and this basic tetrahedral assembly repeats itself in three dimensions to build the ice crystal. When ice melts to form liquid water, the uniform three-dimensional organisation of the solid breaks down as thermal motions disrupt, distort, and occasionally break hydrogen bonds. At ordinary temperatures, these bonds are disrupted by thermal motions almost as quickly as they form [2].

Theoretical studies have shown that certain specific cyclic arrangements, so-called ‘clusters’, of three, four, and five H₂O molecules are especially stable, as is a three-dimensional hexamer (six molecules) that has a cage-like form [2]. Different models have indicated building of stable clusters of several hundreds of water molecules [3] [4] [5]. However, the lifetime of the clusters is estimated at around 10 to 100 picoseconds [1] [2].

With regard to the short lifetimes of the clusters in water, can one then say that liquid water exhibits an ‘inter’-molecular (cluster) structure in addition to its well known ‘intra’-molecular structure?

The word ‘structure’ has a different meaning when applied to liquids than when it is applied to solids. In liquids the molecules are in constant translational motion, but yet they may travel in non-crystalline clusters. Even though this means that long-range order is lost, there is still some short-range order. In water, the extensive hydrogen bonding increases the distance over which this short-range order exists [6]. “Whilst the molecular movements within liquid water require the constant breaking and reorganisation of individual hydrogen bonds on a picosecond timescale, it is thought by some that the instantaneous degree of hydrogen-bonding is very high . . . and gives rise to extensive networks, aided by bonding cooperatively. It has been suggested that there will be a temperature-dependent competition between the ordering effects of hydrogen-bonding and the disordering kinetic effects . . . . There are many pieces of evidence indicating that the time-averaged hydrogen-bonded network possesses a large extent of order.” [7] Hence, according to that stated above, liquid water may be said to exhibit an ‘inter’-molecular structure.

Vortex Mechanics of Water

Vortex motion is a centripetal suctional process that causes matter to move inwards, following a spiralling, whirling path towards the centre of the vortex. Examples of vortices may be seen in nature in the form of whirlwinds, cyclones and tornados, and in the form of movements of water which may be clearly seen when water whirls down through the plug-hole of a bathtub.

A characterising property of a vortex is that its exterior moves slowly and its interior moves fast. A vortex can be described by its size and its circumferential velocity. Another important parameter is the ‘vorticity’, which is the curl of the velocity. The vorticity is a measure of the ‘intensity’ of a vortex. An important mechanism that enhances the vorticity is the stretching of the vortex—stretching along the axis of the vortex makes it rotate faster and decreases its diameter in order to maintain its kinetic momentum constant [8].

As water whirls in the form of a vortex, suspended particles, which are denser than water, are sucked into the centre of the vortex flow. If you stir up a vortex with a spoon in a glass of water in which loose particles such as sand swim around, you can see how the particles gather centrally in the bottom of the glass. This effect can be explained by Bernoulli's equation, that relates the pressure, flow speed and height for flow of an ideal fluid: the difference in pressure (work per unit volume) is equal to the sum of changes in kinetic and potential energies per unit volume that occur during the flow. As water whirls, the speed of flow becomes higher nearer the centre of the flow, and hence the pressure becomes lower nearer the centre. Therefore, suspended particles are sucked by the pressure difference into the centre of the vortex flow.

A vortex in water generates mechanical forces which affect the water molecules. Since different layers of water in a vortex rotate at different speeds, water molecules between the different layers are subjected to mechanical tension [9]. Further, stretching of the vortex, e.g. by the force of gravity, gives additional stress on the water. These mechanical forces of a vortex give rise to, sometimes measurable, remaining changes of the molecular structure of water. It is stated that when water whirls in a vortex, its temperature decreases and its density increases [10] [11].

Since the outer electrons of the hydrogen-oxygen bonds of water are in orbital spin, and a moving charge generates a magnetic field, each water molecule is a tiny magnet. This makes water very sensitive to magnetic fields. When water whirls, its tiny dipole magnets tumble around each other. If the movements of water molecules are random and disorderly, water's overall energy is neutral. However, in certain situations—such as when water moves coherently in a vortex—charged trace elements of other larger molecules added to the water generates an electromagnetic force. Via this generated electromagnetic force, the larger molecule's energy of motion—kinetic energy—may be captured by the water molecules in the form of increased electron spin [9]. This higher spin energy alters the attraction force between the hydrogens in the water molecule and thereby the angle between them.

If the angle between the hydrogens is decreased, the polarisation in the water molecule is increased and thus the hydrogen bonds to adjacent molecules become stronger. If the polarisation of a majority of the water molecules in this way is increased, the surface tension of water is also increased. If the angle between the hydrogens is increased, the polarisation in the water molecule is decreased, whereby the hydrogen bonds to adjacent molecules become weaker. If the polarisation of a majority of the water molecules is decreased, this decreases the surface tension of water.

As described above, the vortex motion of water affects the water molecules via electromagnetic forces (as well as mechanical forces), but can electromagnetic fields have any permanent effects on water? According to Chaplin, one of the curious facts, concerning reports of the effects of magnets and electromagnetic radiation on the properties of water, is the long lifetime these effects seem to have [13].

Harmonic Resonance of Water

The physical phenomenon of ‘resonance’ is well known within the whole area of physics—from elementary-particle physics to acoustic systems. ‘Harmonic resonance’ as defined herein means resonance transmission between two objects with matching natural frequencies, e.g. two water molecules. Harmonic resonance occurs for example when one strikes a note on a string of one guitar, and the corresponding string of another equally tuned guitar in the same or an adjacent room automatically starts vibrating too. By harmonic resonance, energy is distributed among different but equally ‘tuned’ objects.

A fundamental property of the resonance phenomenon is that if the frequency of the energy supply to a system corresponds to the natural frequency of the system, a very small stimulation may cause a large amplitude of the oscillation of the system. One distinguishes between undamped (ideal) oscillation, where the amplitude grows to infinity, and damped (real) oscillation, where the oscillation is restrained from growing in amplitude.

In the mechanical world that we see around us, damping in the form of friction against surrounding matter causes oscillation to fade out after a short while if the stimulation ceases. In the molecular world, however, there is no such friction but instead forces in the form of electric and magnetic fields from adjacent particles which damp, sustain or alter oscillations. Hence, in certain circumstances, oscillations—or vibrations—in a molecular system may be sustained for a long period of time, and because of harmonic resonance the sustained vibrations may propagate to nearby molecules.

Applied to water, the phenomenon of harmonic resonance makes it possible for vibrational energy, such as from increased electron spin, to be distributed among several water molecules, not only in liquid water, but also in air because of the atmospheric humidity.

Prior Art Devices for Whirling Water

‘Implosion’, which is the opposite of ‘explosion’, is an underlying principle of many natural processes. This principle was discovered by the Austrian forester and inventor Viktor Schauberger during the first half of the twentieth century [14]. Schauberger's inventions were related to water supply, natural river regulation, agriculture, driving and energy generation and were all based on the principle of implosion (see for example the patents AT 134543B, AT 196680B, U.S. Pat. No. 1,775,871, AT 142032B, AT 117749B, and AT 145141B). Schauberger saw implosion as the ‘life generating’ principle and explosion as the ‘life degenerating’ principle.

Schauberger's discoveries and ideas have been followed up by, among others, Dolly Knight and Jonathan Stromberg at the Center for Implosion Research (Plymouth, UK). They have developed products such as the ‘Original Vortex Water Energiser’ and the ‘Personal Harmoniser’ which both build on the principle of implosion and utilise the above-described phenomenon of harmonic resonance [15]. Two studies have been published on the Internet which indicate that these products may have effect on the structure of water [16] [17]. These products comprise vortex-shaped copper tubes which include water which has been whirled fast in a specially made implosion apparatus [18].

Another product on the market which is said to affect the structure of water is the ‘Water Revitaliser’ from Nordic Living Water Systems (North Vancouver, Canada). This product consists of a bent water pipe which may be mounted e.g. on a water tap [19].

A third prior art product said to affect the structure of water is the ‘Structuriser’ put on the market by Healthforge (see [12]). It looks like two bottles with their openings put together. When water is poured from one bottle into the other, the water flows in the form of a vortex.

Problems in Fields of Application of the Invention

In metalworking industry, cutting fluids are used in the metalworking machines for cooling, lubrication and flushing of the metals and tools. Much effort has been made to optimise the performance of cutting fluids in order to ensure high cutting rates, minimize tool wear and achieve high-quality surface finish. However, if the performance of the cutting fluids could be further improved, that would reduce the material costs and delivery periods and give even higher quality of the products.

The world-wide problems of environmental pollution are well known. A large quantity of the pollution comes from traffic. In order to purify the exhaust gases from vehicles, exhaust emission control devices are used. Especially for larger vehicles such as trucks, it is important with efficient particle filters to reduce the particle emission. However, these particle filters are relatively expensive and complicated, and not hundred percent efficient. If improvements could be made within this area of technology, that would result in gains both for the vehicle industry and for the environment.

Today, humans as well as all other living organisms are exposed to a huge variety of electromagnetic fields from electrical power supply lines and different types of electrical equipment. As a consequence, an increasing number of people suffer from so-called electrical hypersensitivity, with symptoms such as headache, fatigue, itching, pain, burning sensations in skin, and symptoms from the heart, the central nervous system and the respiratory system. In severe cases, people cannot work in ordinary office environments, or cannot tolerate electromagnetic fields at all. Effort has been made to ground and shield electrical equipment in order to reduce the radiated electromagnetic fields. However, shielding and grounding all electrical equipment in an environment is most often a disconsolate, or even impossible, as well as expensive and time consuming task. A simple means of reducing the negative effects of electromagnetic fields on humans and other organisms would be most welcome.

### SUMMARY OF THE INVENTION

One object of the present invention is to improve the performance of a coolant, such as for a metalworking machine or an engine.

Another object of the present invention is to provide a simple but effective means for exhaust emission control, such as for a vehicle or an industrial plant.

Another object of the present invention is to provide an effective means for reducing the effect of electromagnetic radiation in an environment.

Yet another object of the invention is to provide alternative devices for whirling liquids comprising water.

Still another object of the invention is to provide a method of manufacturing a product for reducing the effect of electromagnetic radiation, or at least its negative effects on humans, animals, plants, etc.

In order to satisfy these and other objects, there is provided a device according to claim 1, a device according to claim 7, a method according to claim 12, a method of manufacturing according to claim 14, and different uses according to claims 16-18. Preferred embodiments appear in the dependent claims.

More specifically, according to the present invention, a device for whirling a liquid comprising water is characterised by a vortex unit comprising seven essentially parallel elongate helical elements, of which six are positioned around the seventh.

By ‘elongate helical’ is herein meant the property of forming a three-dimensional helical curve which is turned around an axis, wherein the different turns around the axis either have essentially the same radial distance to the axis or different radial distances to the axis, such as in a conically increasing or decreasing arrangement. Hence, it is not the kind of helical form constituted of a two-dimensional curve turned several times around the same point in space with an increasing distance to the point which is intended.

Evidence of the technical effect of the present invention has been provided independently by two different metalworking laboratories and a company which produces cutting fluids for metalworking industry. They have tested a device as shown in FIG. 2 of the accompanying drawings (see also the following detailed description), which device in the following will be referred to as ‘the vortex device’.

One of the metalworking laboratories is Metallic AB, outside Ängelholm in Sweden. They have evaluated the effective differences in performance of their metalworking machines when using a coolant, or specifically a cutting fluid, exposed to the vortex device versus when using an ‘unexposed’ cutting fluid. When using the vortex device in metalworking they have found advantages which give better economy. They have obtained the following results in their tests of using the vortex device:
Machine type used: Leadwell™ MVC-1300P
Material: Aluminium 4112
   Iron 1312
Cutting fluid: FUCHS Ecocool™ alu-cf, semisynthetic, mixed traditionally with water, but the water has flown through the vortex unit of the vortex device
Running-in of tool: Running-in of a tool is important in order to achieve a long lifetime of the tool. Normally it takes 3-4 runs to run in the tool. When using the vortex device it takes 10-12 runs, which indicates that there is considerably less wear on the tool.
Increased lifetime and speed when milling and drilling: Fast steel tools Vedevag were used. When applying the vortex device, on average approximately 40% longer lifetime of the tools was achieved at the same time as they were run on average at 20% increased speed.
   For example, milling a hole with 20 mm shank-end mill, depth 8 mm and diameter 28 mm, could without the invention be made in approximately 1000 pieces of steel before the tool was worn out. When applying the vortex device the same could be done in approximately 1400 pieces of steel.
   The above percentage average values are calculated from drilling and milling approximately 2000 pieces a week, respectively, during 14 weeks, which gives about 40 tools as basic data.
Increased lifetime and speed when tapping: An M10 screw-tap was used in iron 2172, 20 mm deep holes. Without the vortex device approximately 5000 tappings could be made before the screw-tap was worn out. When applying the vortex device over 10 000 tappings could be made at 30% increased speed, under the same circumstances as to the rest.
Band-sawing: Corresponding results were achieved when applying the vortex device to band-sawing.

The other metalworking laboratory which has tested the vortex device is BN-Teknik AB, Eksjö, Sweden. They have also evaluated the effective differences in performance of their metalworking machines when using a cutting fluid exposed to the vortex device versus when using an unexposed cutting fluid. They have obtained the following results in their tests:
Machine type used: Makino™ A55-E
Material: Cast aluminium leg. 46000
Cutting fluid: Cooledge™ 2000, mixed traditionally with water, but the water has flown through the vortex unit of the vortex device
Increased lifetime and speed when tapping: A screw-tap M6 0.75 mm was used.

Without the vortex device the tap lasted about 600 cutting minutes, working 400 pieces. With the vortex device the tap lasted approximately 800 cutting minutes, working 530 pieces. The tapping still worked at 110% feeding speed during 4 days. When running at 120% speed the lifetime of the M6 0.75 mm screw-tap was approximately 600 minutes without the vortex device and approximately 1200 minutes with the vortex device. The statistical basic data of the results at BN-Teknik AB is not so large as that of Metallic AB. However, the results at BN-Teknik AB does confirm the results at Metallic AB.

Binol AB Karlshamn is a company which produces cutting fluids for metalworking industry. They have tested whether water exposed to the vortex device and unexposed water have different properties in a simple test for evaluating the wear durability of metals.

They use Reichert equipment for evaluating the wear durability. They tested with ordinary tap water versus water which has flown through the vortex unit of the vortex device. In this test no cutting fluids were used.

The result of the test was that the lubrication capacity of the water exposed to the vortex device was between 7% and 10% higher than that of the unexposed tap water.

As seen from the tests conducted by the two different metalworking laboratories and the cutting fluid producing company, the device according to the invention does improve the effect of the coolant for a metalworking machine. Despite of several independent tests indicating positive results regarding the function of the inventive device, it is not yet fully investigated which mechanisms that are behind the achieved effects. However, the fact that both the lifetime of the tools and the speed of the processes could be increased indicates that the cooling and lubricating effects of the cutting fluids were increased by the vortex device. Since the only difference in the tests was that the water of the cutting fluid had flown through the vortex unit of the vortex device, this should mean that the properties of the water did change. Changed properties of the water implies a changed molecular structure of the water.

Regarding which properties of the water were changed, a guess is that its thermal conductivity was increased—which gives more efficient cooling—and other properties which the thermal conductivity depends on, such as the viscosity of the water [20]. The thermal conductivity of water increases with temperature up to about 130° C. [20] [21]. Since it is not desired to increase the temperature of a coolant in order to increase its thermal conductivity, the present invention seems to provide a welcome solution.

So, how then does the vortex device change the molecular structure of water? The answer should lie in the effects of the special vortex motion of the water induced by the vortex unit of the vortex device.

If you hold a spiral under a water tap and pour water through it, you can actually see how the flow turns into a vortex, following the direction of the spiral. Water does not need much ‘stimulation’ at all in order to start flowing in the form of a vortex, since vortex flow ‘comes natural’ to water. Hence, it is easy to guide water into a vortex flow by exposing the flowing water to a helical form.

According to the above-described evidence for this aspect of the present invention, the use of the vortex device improves the performance of the coolant. However, exposing water to only one spiral—one helical element would not result in any easily recognisable improvement of a coolant's performance. According to the invention, a device is used comprising several, more precisely seven, helical elements arranged in a certain way. The coolant, or the water of the coolant, is preferably led through the vortex unit of the vortex device in order to become exposed to the helical elements. Since the present invention evidently does improve the performance of a coolant, it follows that seven helical elements arranged as stated above amplify the effects of each other—the seven vortices built up become superimposed, whereby the re-structuring forces on the water molecules become stronger.

As water flows through a helical element and starts moving in the form of a vortex, probably only a part of the water molecules become substantially energetically affected, presumably by increased electron spin. What the inventive device most likely does, is to cause a large amount, or yield, of ‘energized’ water molecules. By means of above-described harmonic resonance, the excess energy of the affected water molecules may be distributed to other water molecules.

A pilot study made by MTC, Haninge, Sweden [22] according to the European driving cycle demonstrated a clear reduction of the emission of carbon monoxide, hydrocarbon, nitrogen oxide, carbon dioxide and above all nanoparticles from a petrol-powered vehicle from a first driving test without an emission control device, which relates to said vortex device, to a second driving test involving said emission control device. In two subsequent tests without the emission control device, however, the reduction in emission was maintained at approximately the same level.

Total average values from the four driving tests (without, with, without, without emission control device) indicated that the emission of controlled components decreased by 6-8% while the emission of nanoparticles decreased by 20%. If this, or possibly a greater, reduction of the emission of nanoparticles can be confirmed by new studies, the present invention could result in great gains both for the vehicle industry and for the environment since the vortex device is considerably less expensive to manufacture and mount on a vehicle than conventional particle filters.

As mentioned under Vortex Mechanics of Water, suspended particles in water are sucked into the centre of the flow of a vortex motion. Similarly, particles of the exhaust emission flowing through the vortex unit are sucked into the centre of the vortex flow induced by the vortex unit. Thereby the particles may agglutinate into larger aggregates which are so dense that they fall down and therefore cannot be measured as exhaust gas contents—but could be collected.

However, that hypothesis alone does not explain why the two subsequent tests without the emission control device did not result in the same clear difference in emission but a sustained lower emission. A complementary explanation could be that there was a ‘remaining’ effect on the environment. Here the above-mentioned phenomenon harmonic resonance might play a role, the effect of the emission control device on water molecules being propagated via the atmospheric humidity and thus giving a remaining change of the environment in the vehicle and in the test premises.

The following test with a simple volt sensor has been made with successful result several times and during different circumstances. The test gives proof of the ability of said vortex device to reduce the effect of electromagnetic radiation in an environment.

A simple volt sensor for detecting alternating current 50/60 Hz in the interval 70-440V without direct contact has been used. Such devices are usually used for detecting electric cables in walls. If there is a measurable magnetic field from an electric source, the volt sensor will give a buzzing sound and its diode will give light.

The volt sensor was held in front of a source of weak electromagnetic field, in this example a turned on lamp—the volt sensor sensed the magnetic field from the lamp and gave sound and light.

A glass of ordinary tap water was held between the lamp and the volt sensor—it still gave sound and light.

A glass of tap water which had flown through a vortex device according to FIG. 2 was held between the lamp and the volt sensor—it did not give sound and light.

A relatively great study involving fifty test subjects has been made [23], which demonstrates that exposure to electromagnetic radiation from a turned on display in an office environment causes a stress load on the heart muscle of an individual in the form of increased sympathetic activity, and that the presence of an ‘active’ begonia, i.e. a pot plant of the species Begonia Elatior watered with water exposed to said vortex device according to FIG. 2, in the same environment with the display turned on gives a stress reducing effect on the individual. The stress reduction was demonstrated by reduced sympathetic and increased parasympathetic activity, lowered heart rate and increased power of recovery. The stress reducing effect was still there for a while after removing the active begonia. Also a ‘control begonia’ watered with ordinary tap water appeared to have a stress reducing, parasympathetic, and stabilising effect on the individual's heart, which confirms previous studies. The stress reducing effect of the active begonia, however, was significantly greater. In particular, the effect on the heart rate was different. Thus the study demonstrates that the presence of a begonia watered with water exposed to said device in an indoor environment changes this environment in a positive manner, which significantly reduces the stress load owing to exposure to electromagnetic radiation. The study will be described in more detail in the following.

Object

The object of this study was to determine the effects of indoor vegetation on conditions in an office environment with regard to heart rate and heart rate variability, when exposed to an electromagnetic field (EMF) from a display while working at a computer.

Method

Fifty healthy voluntary test subjects, 25 women and 23 men, were sitting in an ordinary computer working posture in front of the display. Electrocardiography (ECG) was measured in five succeeding tests of ten minutes, of which the first test was made when the display was turned off while the other tests were made with the display turned on. During tests three and four, one of two pot plants of the species Begonia Eliator was watered during growth with ordinary tap water or with “active” tap water that had flown through a vortex device according to FIG. 2 in the accompanying drawings, placed on the right side of the display, between the test subject and the display. Heart rate, heart rate variability (HRV) and power special density (PSD) were registered, analysed and compared in relation to control values.

Results

The heart rate was found to be unaffected when directly exposed to EMF. Time domain analyses indicated a significantly reduced heart rate in the presence of the ‘active’ pot plant, and in the absence of pot plants during the last test. The HRV increased significantly followed by a consistently higher vagus tone in the presence of, and later in the absence of, an active pot plant. PSD parameters revealed significantly higher total rate variance and autonomous activity, which caused a significant increase in low frequencies (LF) and high frequencies (HF) in the presence of an active pot plant, which increase was maintained after the removal of the pot plant. In direct exposure to EMF, very low frequencies (VLF) increased while the effect of normalised high frequencies (HF) was decreased, followed by a rise in LF effect and confirmed by an increased LF/HF ratio. The HF effect was higher with an active pot plant than with a control pot plant. Thus, the EMF induced sympathetic activity to parasympathetic control of the heart was changed, especially in the presence of the active pot plant. PSD diagrams demonstrated an intensified spectral band at frequencies in the range 0.1 HZ in the presence of pot plants, in favour of the stability in the autonomous system.

The study proves that an improvement of EMF loaded working environment conditions by adding indoor vegetation causes immediate changes in the oscillation regulation of the heart to vagus-induced sympathovagal balance of the heart. Parasympathetic response was associated with reduced heart rate, which implies building up and maintaining of metabolic energy and bodily resources, partly provided by a perception-related involuntary adaptation to an outer plant-related stimulation.

The study also proves that in addition to the stimulating effect that is obtained on the oscillation regulation of the heart by a pot plant, watering of the pot plant with water exposed to a vortex device according to FIG. 2 results in an additionally improved stimulating effect.

As seen from the above-described proofs of the assertion that the device as used according this aspect of the invention reduces the effect of electromagnetic radiation in an environment, the device obviously is capable of increasing water's ability to absorb electromagnetic radiation.

The effect on the nervous system of the test subjects, which was achieved in the study described above, could probably also be explained partly by the begonia's transpiration of water exposed to said device, the water with its changed molecular structure owing to the atmospheric humidity and the individual's breathing directly affecting the internal environment in the individual's body, thus improving the conditions of the individual's body of resisting the stress caused by the electromagnetic field.

In one embodiment of the invention, said elongate helical elements each comprise a helical string. This gives a simple but effective construction of the device.

In another embodiment of the invention, said elongate helical elements each comprise a threaded hole, wherein threads in the hole constitute a helical form. This embodiment gives, for instance, other constructional benefits—it may be made small and thin, and it is easy to manufacture.

In yet another embodiment of the invention, said elongate helical elements are conical. The conicity of the helical elements enhances the effect of the vortex unit because this shape corresponds even more to the shape of a natural vortex.

According to another aspect of the present invention, a device for whirling a liquid comprising water is characterised by two vortex units which each comprise seven essentially parallel elongate helical elements, of which six are positioned around the seventh, wherein one of the vortex units has three helical elements turned clockwise and four turned counter-clockwise, whereas the other vortex unit has four helical elements turned clockwise and three turned counter-clockwise.

Said elongate helical elements may each either comprise a helical string or a threaded hole. They may further be conical.

Evidence of the technical effect of this aspect of the invention is given by its application in another aspect of the invention to be mentioned next.

According to this other aspect of the present invention, a method of manufacturing a product for reducing the effect of electromagnetic radiation in an environment is characterised by the acts of exposing a liquid comprising water to a device according to claim 7, by allowing the liquid to flow through the vortex unit of said device, allowing said product to absorb said exposed liquid, and drying said product, whereby an imprint of the exposed liquid in the product is made, which imprint effects said reduction of the effect of the electromagnetic radiation.

The product can be made extremely simple and smooth to use. For instance, it can be arranged inside the cover of a mobile telephone and thus counteract the negative effects of the radiation of the mobile telephone on the human body, or be arranged at a display to counteract the effects of radiation from the display. A product manufactured according to the inventive method can also be used as shielding in buildings, or as shielding round electric cables or transformer cabinets, said shielding protecting the environment from generated electromagnetic fields. Furthermore the inventive method is extremely applicable in papermaking—all products containing paper, such as books, newspapers and magazines, copying paper, wall paper, etc, can thus have the property of being able to affect the molecular structure of surrounding water and, consequently, being able to cause positive effects on the health of individuals.

The following test with a simple volt sensor according to above has been made with successful result several times and during different circumstances.

The volt sensor was held in front of a source of weak electromagnetic field, in this example a turned on lamp—the volt sensor sensed the magnetic field and gave sound and light.

A newspaper or even a telephone directory was held between the lamp and the volt sensor—it still gave sound and light.

A product in the form of a piece of paper manufactured as stated above was held between the lamp and the volt sensor—it did not give sound and light.

This proof of the technical effect of the fifth aspect of the invention also gives evidence of the technical effect of the previously described aspect of the invention, since the product is manufactured by using a device according to that aspect of the invention. A product which has absorbed water exposed to a device comprising only one vortex unit has no such easily detectable effect on electromagnetic radiation; hence, the energetic effect of the device according to the previously described aspect of the invention is stronger.

At normal temperatures and atmospheric humidity, there is always a thin film of water on the surface of every object, even when the object feels dry. On a molecular level, water penetrates all objects, more or less deeply depending on the molecular structure of the object.

When an object, such as a piece of paper, first has absorbed water exposed to a device according to this aspect of the invention and then has dried, it will still have an effect on electromagnetic radiation. That is probably because the inventive device has the ability to energetically affect a relatively large share of the water molecules flowing through the device, and because the once soaked object never dries entirely—there will always be water within and on the surface of it. Because of the harmonic resonance between water molecules the energetic, or vibrational, ‘information’ stored by water molecules within and on the surface of the object will be distributed to surrounding water molecules in the air around the object. The energetic state of the water molecules induced by the inventive device could have a long half-life period, whereby the effect of the object on its environment could last for maybe years. The energetic water might also have an effect on the molecules of the product matter.

In one embodiment, said product comprises board. Board, or paper, is an easily accessible material that is light and easy to shape and that in a stable manner can store an imprint of the molecular structure of the exposed water.

The above evidence and practical experience of the present invention indicate that it can be used within many different fields of application. A basic explanation thereof is that there is water practically everywhere. Examples of fields of application are
indirect protection of human beings, animals and plants against electromagnetic radiation, for instance by placing water exposed to, for instance, one of the different devices described in the detailed description or by placing the actual device in an indoor environment;
mounting such a device on incoming water conduits to buildings, mounting the same on distribution poles, radio masts or base stations for mobile communication;
placing pieces of board carrying the structure of dried, exposed water inside the cover of mobile telephones, in office environments, etc.;
purification of water in waterworks and to buildings for reduction of toxic contents; it has been found in a minor study that the content of lipopolysaccharide endotoxin (biological poison produced by bacteria and blue-green algae) in water is considerably reduced when exposing the water to the vortex device according to FIG. 2;
treatment of water in rivers, watercourses, lakes, sea etc. for purification and stimulation of good and abundant flora and fauna; it has been found that both flora and fauna in the river of Esse at Pietarsaari, north-east of Vaasa, in Finland have been improved after placing a vortex device according to FIG. 2 (a large one) in the river;
reduction of environmental influence from exhaust gases and emission of chemicals, for example by mounting the device on exhaust pipes of vehicles or in chimneys and other outlets of factories;
stimulation of growth and improvement of the quality or indoor and outdoor plants, especially in controlled cultivations; it has been demonstrated in several independent tests that the quality of plants is improved when watered with water exposed to the device;
influence on diet factors such as vegetables, fruit, beverages and other foodstuffs;
affecting sanitary articles and cosmetics;
strengthening the health of individuals consuming such diet factors and exposed water directly;
etc.

### BRIEF DESCRIPTION OF THE DRAWINGS

The invention will now be described in more detail with reference to the accompanying drawings, in which

FIG. 1 is a perspective view of one embodiment of a device according to the invention;

FIG. 2 is a perspective view of another embodiment of a device according to the invention;

FIG. 3 is a perspective view of a device according to FIG. 2 contained in a cylindrical housing to be mounted, for instance, in a water conduit;

FIG. 4 is a perspective view of yet another embodiment of a device according to the invention;

FIG. 5 is a perspective view of another embodiment of a device according to the invention, comprising two opposing and ‘opposite’ vortex units;

FIG. 6 is a perspective view of another embodiment of a device according to the invention, comprising a vortex unit with helical elements in the form of threaded holes; and

FIG. 7 is a perspective view of still another embodiment of a device according to the invention, comprising two opposing and ‘opposite’ vortex units with helical elements in the form of threaded holes.

### DETAILED DESCRIPTION OF PREFERRED EMBODIMENTS

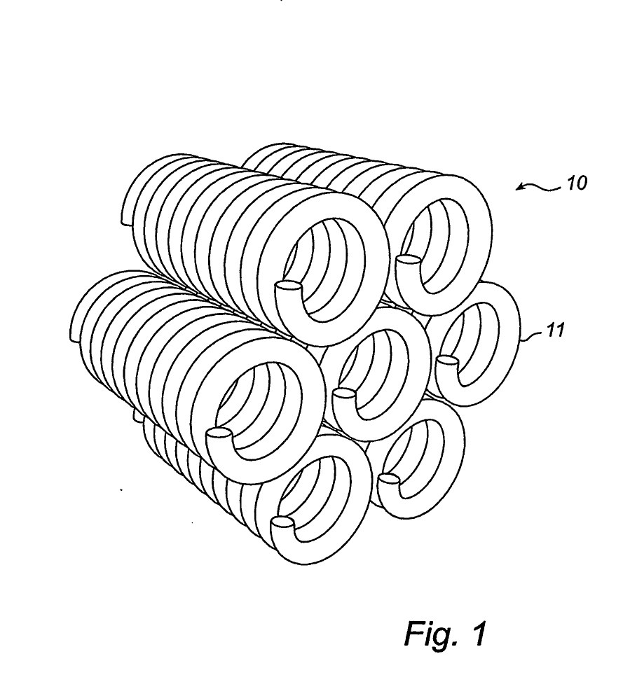

FIG. 1 illustrates a device according to the invention for whirling a liquid comprising water. The device comprises a so-called vortex unit 10, which comprises seven helical elements, here in the form of seven helical strings 11, each string surrounding a cylindrical space.

The helical elements are arranged so that their ‘cylinder axes’ are essentially parallel. Thus, it is not necessary that the cylinder axes be exactly parallel for the inventive, molecular structure changing effect on water to be achieved, but the more parallel the cylinder axes the better will the device probably function.

The seven helical elements are arranged so that six helical elements are positioned around a seventh helical element, that is to say the six helical elements are arranged in a circle around the seventh helical element.

In this embodiment, where each helical element surrounds a cylindrical space with an essentially constant diameter along the entire length of the cylinder axis, the seven helical elements each comprise an odd number of entire helical turns—in FIG. 1, the helical strings 11 have eleven helical turns each. It has been found that the effect on the device on water is greater if the number of helical turns is odd, and it has also been found that the effect generally seen increases with an increased number of helical turns, at least up to a certain limit. That more turns give a greater effect may be explained by the fact that the water molecules flowing through the vortex unit are affected during a longer distance. That the effect of the device is greater with an odd number of turns of the helical elements and with a larger number of turns is valid in general, and thus this applies to all the embodiments described herein.

The material of the helical elements is preferably stainless steel, which is a dimensionally stable material that withstands exposure to moisture for a long period of time. However, practical experiments have shown that the helical elements can be made of any dimensionally stable material, such as a different metal, plastic or wood.

For the helical elements to remain in the above-mentioned relative positions, they can be, for instance, welded to each other at a few points.

With the device shown in FIG. 1 and comprising the vortex unit 10, it is thus possible to effect a change of the molecular structure of water.

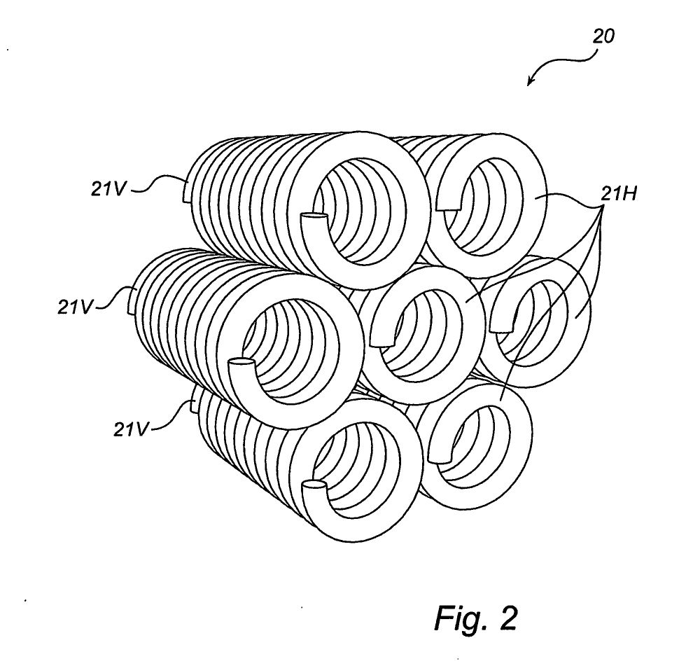

FIG. 2 shows another embodiment of a device according to the invention, which, as mentioned above, differs from the device shown in FIG. 1 only by having helical elements turned in opposite directions. More specifically, four of the helical elements, including the seventh in the centre, here the helical strings 21H, are turned in one direction of rotation, here clockwise, while three of the helical elements, here the helical strings 21V, are turned in the opposite direction of rotation, here counterclockwise. Precisely this characteristic, that the device has helical elements turned in opposite directions, has by practical experience been found to give a certain ‘energy-balancing’ effect on the human body.

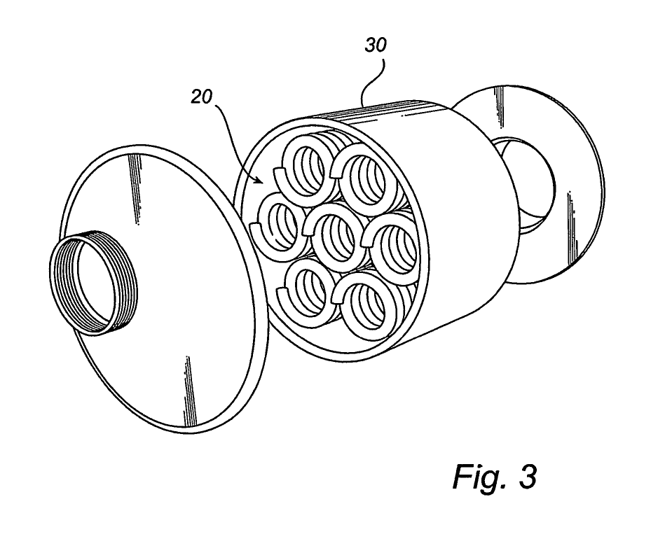

A device comprising a vortex unit, such as the vortex unit 10 in FIG. 1 or the vortex unit 20 in FIG. 2, can be used in various ways. It may be connected to a water conduit or be mounted on a water tap in order to mechanically affect water flowing through the water conduit or the water tap. The mechanical action makes the water flow in a particular vortex formation in accordance with the design of the vortex unit. It is convenient to fit the vortex unit into a housing which can be mounted as a link of a water conduit, as shown in FIG. 3, with the vortex unit 20 placed in a cylindrical housing 30. The device may also be arranged in a water tank or the like, or in natural watercourses. The device can to a certain extent affect water even when it is located ‘outside’ the water/water flow in question, for instance in the air beside the water flow. The helical elements are preferably arranged parallel to the water flow.

The explanation why the device functions also outside the water flow lies in the device also having an effect on air, since air carries a certain amount of water depending on the degree of atmospheric humidity. Air passing through the vortex unit is made to spontaneously begin to flow like a whirlwind, in which case the water molecules in gas phase are capable of absorbing the kinetic energy that is generated in the vortex (see the previous discussion under Vortex Mechanics of Water).

Owing to the above-mentioned harmonic resonance (see Harmonic Resonance of Water), the effect of the device can be distributed between water molecules in air and in water. Thus, the device makes it possible to effect a change of the molecular structure also of water that is not directly exposed to the device, but instead indirectly exposed by way of other water molecules in surrounding air, or of course also in surrounding water. For example, by pouring a bucket of water, which has been exposed to the device, into a tank, it is possible to change the molecular structure of water in the entire tank and of water in the air above the tank.

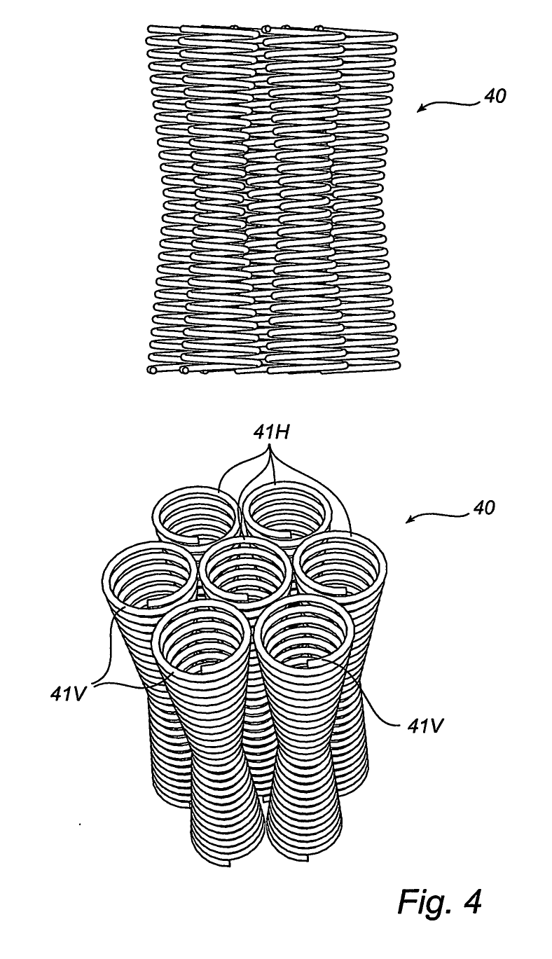

FIG. 4 shows another embodiment of a device according to the invention for whirling a liquid comprising water. The most significant difference between the device shown in FIG. 4 and the device shown in FIG. 2 is that the device shown in FIG. 4 has a vortex unit 40 which comprises helical strings 41V and 41H which are ‘doubly conical’, that is to say the diameter of each helical string tapers from the ends of the string towards the centre of the string like in a cone, so that a ‘waist’ forms in the centre of each helical string. This conicity has, in addition to a larger number of helical turns, by practical experience proved to give a stronger effect, probably in the form of increased additional energy as mentioned in the introductory part, of exposed water. The vortex unit 40 shown in FIG. 4 can, like the vortex unit 20, be mounted in a housing as shown in FIG. 3 to be connected to a water conduit.

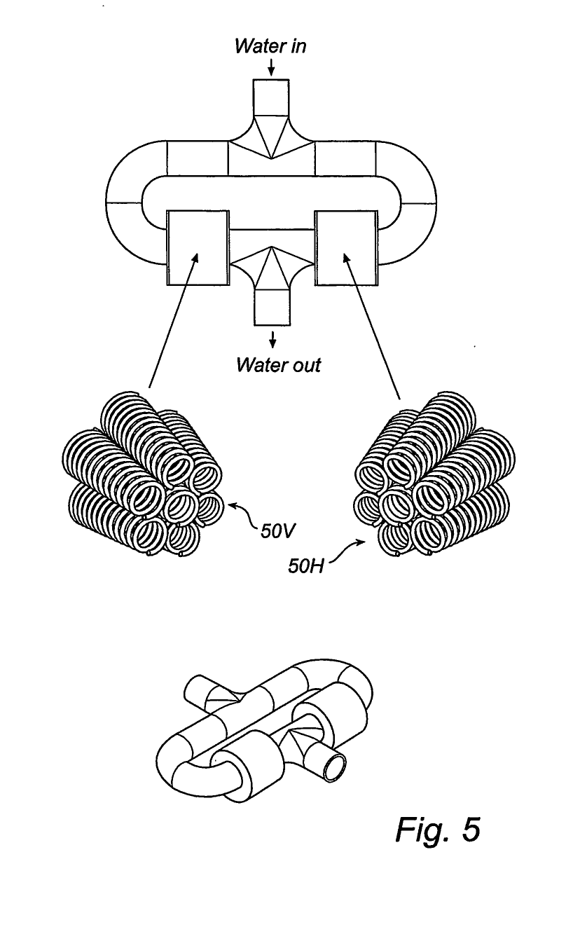

FIG. 5 shows a device according to the present invention for changing the molecular structure of water, which comprises two opposing, ‘opposite’ and conical vortex units 50V and 50H. The vortex units 50V and 50H are opposed in such a manner that they are arranged parallel along the same line, the narrow ends of the helical strings of the vortex unit 50V being directed towards the corresponding narrow ends of the helical strings of the vortex unit 50H. The vortex units 50V and 50H are also ‘opposite’ in such a manner that the helical central string of the vortex unit 50V is turned counterclockwise while the central string of the vortex unit 50H is turned clockwise. Of the surrounding helical strings of each vortex unit 50V, 50H, three are turned clockwise and three are turned counterclockwise.

The combination of the effects from two vortex units on the same water, which preferably are arranged in the above-described opposing and ‘opposite’ relationship, seems to create a certain synergy effect, probably by providing an increased yield of energetically affected water molecules. In other terms, when including two vortex units, the device becomes more effective.

The vortex elements 50V and 50H can advantageously be mounted in a water conduit as shown in FIG. 5, so that water can be made to flow through the respective vortex units 50V and 50H from the “thick” end to the “narrow” end of the vortex unit, and then be combined to one flow after leaving the respective vortex units 50V and 50H.

The two vortex units 50V and 50H need not be conical, but as mentioned above the effect has been found to be increased by the conical shape owing to an increase of the implosion effect, which has been mentioned in the introductory part of the description.

The device which is shown in FIG. 5 can be used to manufacture a product that can also be used to change the molecular structure of water in an environment in which the product is placed. This change of structure of water in the environment can in turn affect individuals staying in the environment in such a manner that they are affected less negatively by, for instance, electromagnetic radiation in the same environment (see the results from the begonia study above).

The manufacture of the product is done so that water is exposed to the device according to FIG. 5 by letting it flow through the device, whereupon the exposed water is allowed to wet the material of the product. This material could probably be any material whatever that can absorb water. Suitable examples are paper/board, cardboard, woven material, wood etc. However, there are indications that also metals can be used, which would mean that the material need not be porous at all. The thus wetted material of the product is then allowed to dry, whereby an imprint of the exposed water in the material is provided, which imprint has been found to be able to reduce the effect of electromagnetic radiation.

The product can then be provided in the form of pieces of board to be placed in front of displays and inside covers of mobile telephones, in the form of writing paper and leaves in books, in the form of kitchen paper and toilet paper, in the form of articles of clothing, in the form of interior decoration such as wallpapers, carpets, cloths, curtains, furnishing fabrics etc, in the form of building material such as particle board and insulating material etc.

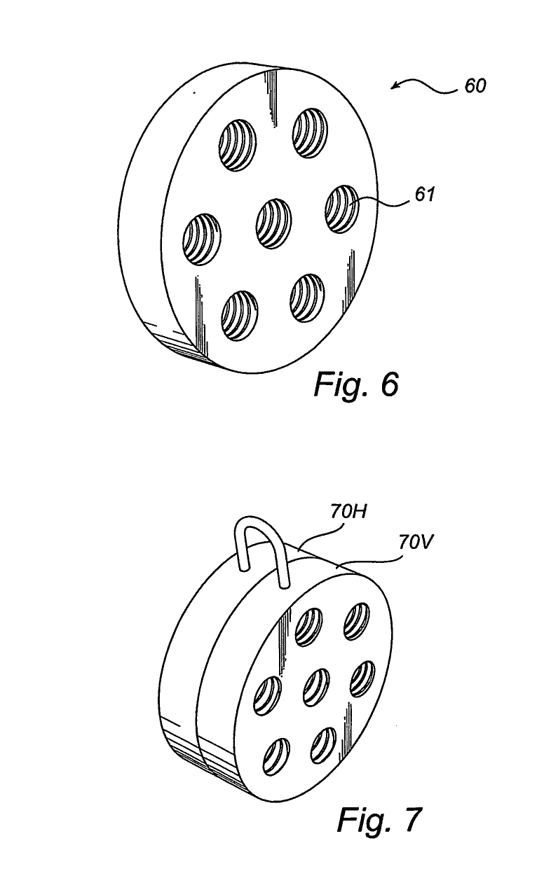

FIG. 6 shows a device according to another embodiment of the present invention for changing the molecular structure of water. In this embodiment, the device comprises a vortex unit 60 which has helical elements in the form of threaded holes 61, instead of helical strings like in the previously presented embodiments. The number of turns of the thread is crucial in the same way as the number of turns of the helical strings stated above, that is to say the number of turns of the thread is preferably odd, and the more turns of the thread the greater the effect. Just as stated above, the threads in all holes can be turned in the same direction, or preferably threads in four holes, including the central one, can be turned in one direction while threads in the remaining three holes are turned in the other direction.

The threaded holes 61 are preferably made in a piece of material, such as a stainless steel metal disc of a suitable thickness. Manufacture can easily take place by drilling seven holes arranged relative to each other as shown in FIG. 6, and the drilled holes are threaded by means of a screw tap.

A device according to this embodiment can, just like previously presented devices, be mounted in a flow of water and thus affect the molecular structure of the water. It can be used for coolant, exhaust emission control and radiation protection just like the devices with helical strings. The device according to this embodiment may be most suited for use in air, in which case it affects water molecules in the air as described above. Since the device can be small and handy, it will be easy to carry about.

FIG. 7 shows a device according to yet another embodiment of the present invention for changing the molecular structure of water. In this embodiment, the device comprises two opposing and ‘opposite’ vortex units 70V and 70H, quite analogously with the device shown in FIG. 5, comprising two opposing and opposite vortex units 50V and 50H. The greatest difference compared with the device as shown in FIG. 5 is that the two vortex units 70V and 70H of the device according to FIG. 7 comprises, instead of helical strings, helical threaded holes, just like the device according to FIG. 6. The vortex units are opposed in such a manner that they are assembled along common hole centre axes, and they are opposite in such a manner that in the vortex unit 70V the central hole is threaded counterclockwise, while the centre hole of the vortex unit 70H is threaded clockwise.

In the same way as in the embodiment according to FIG. 5, the combination of the effects from two opposing and opposite vortex units with threaded holes creates a certain synergy effect in terms yield of energized water molecules flowing through as well as surrounding water molecules by harmonic resonance.

Just like the device according to FIG. 6, the device according to FIG. 7 would probably also be most suited for use in air.

It is to be understood that modifications of the above described devices and methods can be made by people skilled in the art without departing from the spirit and scope of the invention.

### REFERENCES

[1] Morgan, James J. et al: Water, Properties. Kirk-Othmer Encyclopedia of Chemical Technology (online), 4 Dec. 2000, (retrieved on 13 Jan. 2003). Retrieved from the Internet:

http://www.interscience.wiley.com/kirk/articles/propmorg.a01/sectll.html,
[2] Lower, S.: A gentle introduction to water and its structure (online), (retrieved on 3 Mar. 2003). Retrieved from the Internet: http://www.sfu.ca/aqual/aboutwater.
[3] Zenin, S. V.: Hydrophobic model of water molecules associates structure. Journal of Physical Chemistry (Moscow), 1994, Vol. 68, pp. 634-641.
[4] Tsai, C. J. and Jordan, K. D.: Theoretical study of small water clusters. Journal of Physical Chemistry, 1993, Vol. 97, pp. 5208-5210.
[5] Issacs et al: Covalency of the hydrogen bond in ice. A direct X-Ray measurement. Physical Review Letters, 1999, Vol. 82, pp. 600-603.
[6] Chaplin, M.: Frequently asked questions—How can a liquid have a structure? (online), 10 Jan. 2004, (retrieved on 18 Jan. 2004). Retrieved from the Internet: http://www.lsbu.ac.uk/water/notes.html (London South Bank University).
[7] Chaplin, M.: Introduction to water clustering (online), 7 Dec. 2003, (retrieved on 18 Jan. 2004). Retrieved from the Internet: http://www.lsbu.ac.uk/water/intro.html (London South Bank University).
[8] Petitjeans, P.: Stretching of a vortical structure: filaments of vorticity. Europhysics News, 2003, Vol. 34, No. 1.
[9] Yarrow, D.: The spark of life (online), (retrieved on 18 Jan. 2004). Retrieved from the Internet: http://www.championtrees.org/topsoil/firewater.htm.
[10] Knight, D., Stromberg, J.: Water—Nature's miracle (online), (retrieved on 18 Jan. 2004). Retrieved from the Internet: http://www.implosionresearch.com (Published in Acres U.S.A, November 2000).
[11] Baumgartner, W.: Implosion vs. Explosion—There is a new awakening on the horizon! Sample newsletter in Vortex Science, implosion-on line newsletter (online), (retrieved on 18 Jan. 2004). Retrieved from the Internet: http://www.vortexscience.com/pages/free.html.
[12] Healthforge: How the Structuriser works (online), (retrieved on 18 Jan. 2004). Retrieved from the Internet: http://www.healthforge.com/theory.htm.
[13] Chaplin, M.: Magnetic and electric effects on water (online), 9 Dec. 2003, (retrieved on 18 Jan. 2004). Retrieved from the Internet: http://www.lsbu.ac.uk/water/magnetic.html (London South Bank University).
[14] Schauberger, V. (translated and edited by Coats, C.): The water wizard—The extraordinary properties of natural water. Gateway, 1997, ISBN 1-85860-048-0.
[15] Agar, C.: Practical applications of Schauberger Discoveries (online), (retrieved on 18 Jan. 2004). Retrieved from the Internet: http://www.implosionresearch.com.
[16] Schmeikal, B.: On the action of the Vortex Energiser on water. Biofield Laboratory, Vienna, 1998 (online), (retrieved on 14 Jan. 2003). Retrieved from the Internet: http://www.implosionresearch.com.
[17] Coghill, R. and Galonja-Coghill, T.: Protective effect on human peripheral blood lymphocytes of a water-filled metal device (“Personal Harmoniser”) against cellphone radiations at 1800 MHz. Coghill Research Laboratories, Lower Race, Gwent NP4 5UH (online), (retrieved on 14 Jan. 2003). Retrieved from the Internet: http://www.implosionresearch.com.
[18] Retrieved from the Internet (retrieved on 14 Jan. 2003): http://www.implosionresearch.com.
[19] Retrieved from the Internet (retrieved 2003 Jan. 14): http://www.alivewater.net.
[20] Weingärtner, H. et al: Water—Water as a solvent. Ullmann's Encyclopedia of Industrial Chemistry [online], 15 Jun. 2002, (retrieved on 11 Aug. 2003). Retrieved from the Internet: http://www.mrw.interscience.wiley.com/ueic/articles/a28 001/sect1-fs.html.
[21] Chaplin, M.: Explanation of the anomalies of water (online), (retrieved on 18 Jan. 2004). Retrieved from the Internet: http://www.lsbu.ac.uk/water/explan4.html (London South Bank University).
[22] Almén, J.: Undersöning av emissionen från ett fordon med och utan avgasrenare från Plus & Minus AB. Report no MTC 9703, Haninge, Sweden, 2002.
[23] Johansson, B.: The effect of Begonia Elatior on indoor environmental conditions to heart rate and heart rate variability in VDT work. Biobalance AB, Malmö, Sweden, 2002.

1. A device for whirling a liquid comprising water, comprising:
a vortex unit comprising seven essentially parallel elongate helical elements, of which six are positioned around the seventh.

2. A device according to claim 1, wherein said elongate helical elements each comprise a helical string.

3. A device according to claim 1, wherein said elongate helical elements each comprise a threaded hole, wherein threads in the hole constitute a helical form.

4. A device according to claim 1, wherein four of said elongate helical elements are turned in one direction of rotation whereas three of said elongate helical elements are turned in the opposite direction of rotation.

5. A device according to claim 1, wherein said elongate helical elements each comprise an odd number of helix turns.

6. A device according to claim 1, wherein said elongate helical elements are conical.

7. A device for whirling a liquid comprising water, comprising:
two vortex units which each comprise
seven essentially parallel elongate helical elements, of which six are positioned around the seventh, wherein one of the vortex units has three helical elements turned clockwise and four turned counter-clockwise, whereas the other vortex unit has four helical elements turned clockwise and three turned counter-clockwise.

8. A device according to claim 7, wherein said elongate helical elements each comprise a helical string.

9. A device according to claim 7, wherein said elongate helical elements each comprise a threaded hole, wherein threads in the hole constitute a helical form.

10. A device according to claim 7, wherein said elongate helical elements each comprise an odd number of helix turns.

11. A device according to claim 7, wherein said elongate helical elements are conical.

12. A method of whirling a liquid comprising water, comprising:
exposing said liquid to a device according to claim 1, by allowing the liquid to flow through the vortex unit of said device.

13. A method according to claim 12, wherein said liquid is a coolant.

14. A method of manufacturing a product for reducing the effect of electromagnetic radiation in an environment, comprising:
exposing a liquid comprising water to a device according to claim 7, by allowing the liquid to flow through the vortex units of said device,
allowing said product to absorb said exposed liquid, and
drying said product, whereby an imprint of the exposed liquid in the product is made, which imprint effects said reduction of the effect of the electromagnetic radiation.

15. A method according to claim 14, wherein said product comprises board.

16. A method of using a device according to claim 1 for improving the performance of a coolant, such as for an engine or a cutting machine, comprising allowing at least water of said coolant to flow through the vortex unit of said device.

17. A method of using a device according to claim 1 for exhaust emission control, such as for a vehicle or an industrial plant, comprising allowing said exhaust emission to flow through the vortex unit of said device.

18. A method of using a device according to claim 1 for reducing the effect of electromagnetic radiation in an environment, comprising:
allowing a liquid comprising water to flow through the vortex unit of said device, and positioning the liquid in said environment.
